(19) United States
(12) Patent Application Publication
(10) Pub. No.: US 2010/0052533 A1
(43) Pub. Date: Mar. 4, 2010

(54) LAMP AND A METHOD FOR ENHANCING THE ILLUMINATION OF THE LAMP

(76) Inventor: Seo-Yong Cho, Seoul (KR)

Correspondence Address: Seo-Yong Cho, 2-711, Samick Apt., Ichon Yongsan, Seoul, 131-728, KR

(21) Appl. No.: 12/198,385

(22) Filed: Aug. 26, 2008

(51) Int. Cl. H01J 61/18; H01J 61/00

(52) U.S. Cl. 313/638; 313/567

(57) ABSTRACT

A method includes enhancing an illumination of a lamp including coating an interior surface of a discharge vessel of the lamp with a coating material; and heating the discharge vessel. A lamp includes a discharge vessel having a coating material.

### BACKGROUND

Conventional discharge lamps have been developed to protect the discharge vessel from corrosion. To that effect, various surface treatments of the discharge vessel have been suggested. For instance, the interior and exterior surfaces of the discharge vessel were coated with a coating material such as yttrium, zirconium, hafnium, lanthanium, scandium, etc. in order to protect the discharge vessel from corrosion due to discharge gases that are corrosive. However, one drawback to this method is that the coating layer formed by the coating material interferes with the illumination of the discharge lamps.

### SUMMARY

In one aspect, a method is provided, including enhancing an illumination of a lamp including coating an interior surface of a discharge vessel of the lamp with a coating material; and heating the discharge vessel. In some embodiments, the coating material is includes MgO, carbon nanotubes, or a mixture thereof. In some embodiments, the coating material is MgO. In some embodiments, the coating material possesses a large secondary electron emission coefficient. In some embodiments, the large secondary electron emission coefficient ranges from about 0.3 to about 0.5.

In some embodiments, the coating material increases the illumination of the lamp compared to a lamp without a coating material. In some embodiments, the discharge vessel is made of a light-transmissive ceramic. In some embodiments, the light-transmissive ceramic is alumina, silica, yttria, Y₃FeO₁₂, Y₃Al₅O₁₂, or mixtures of any two or more such materials. In some embodiments, the light-transmissive ceramic is alumina.

In some embodiments, the lamp is an electric discharge lamp. In some embodiments, the electric discharge lamp is a sodium vapor discharge lamp. In some embodiments, the coating step includes sol-gel coating. In some embodiments, the coating step includes dip coating. In some embodiments, the heating is from about 300° C. to 700° C.

In another aspect, a lamp is provided including a discharge vessel having a coating material. In some embodiments, the coating material is MgO, carbon nanotubes, or a mixture thereof. In some embodiments, the coating material is MgO. In some embodiments, the coating material has a large secondary electron emission coefficient. In some embodiments, the large secondary electron emission coefficient ranges from about 0.3 to about 0.5. In some embodiments, the coating material protects the discharge vessel from corrosion.

In some embodiments, an interior surface of the discharge vessel is coated with the coating material. In some embodiments, the discharge vessel is made of light-transmissive ceramic. In some embodiments, the light-transmissive ceramic is alumina, silica, yttria, Y₃FeO₁₂, Y₃Al₅O₁₂, or mixtures of any two or more such materials. In some embodiments, the light-transmissive ceramic is alumina.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an illustrative cross-sectional view of a lamp, in according to one embodiment.

FIGS. 2A and 2B are an illustrative perspective view (2A) and a cross-sectional view (2B) of a discharge vessel of a lamp, according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In one aspect, a method is provided for enhancing the illumination of a lamp having a coating material on the surface of the discharge vessel.

In another aspect, a lamp includes a discharge vessel having a coating material.

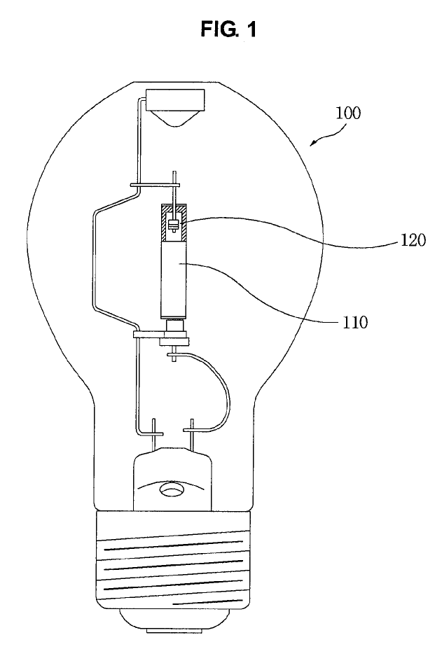

Referring to FIG. 1, a lamp 100 is an electric discharge lamp having a discharge vessel 110. A discharge device 120 is formed inside the discharge vessel 110, and is filled with a discharge gas such as mercury gas, sodium gas, xenon gas, a mixed gas of argon and chlorine, a mixture of two or more such gases, or other discharge gases known to those of skill in the art. As used herein, “discharge gas” refers to a gas that is filled inside of a discharge device.

According to one embodiment, a light transmissive ceramic material that is capable of withstanding a corrosive discharge gas is used as a material for the discharge vessel 110. Such light transmissive ceramic materials include, but are not limited to, alumina (Al₂O₃) silica (SiO₂), yttria (Y₂O₃), Y₃FeO₁₂, Y₃Al₅O₁₂, and mixtures more such materials. Other materials known to possess similar properties are also included.

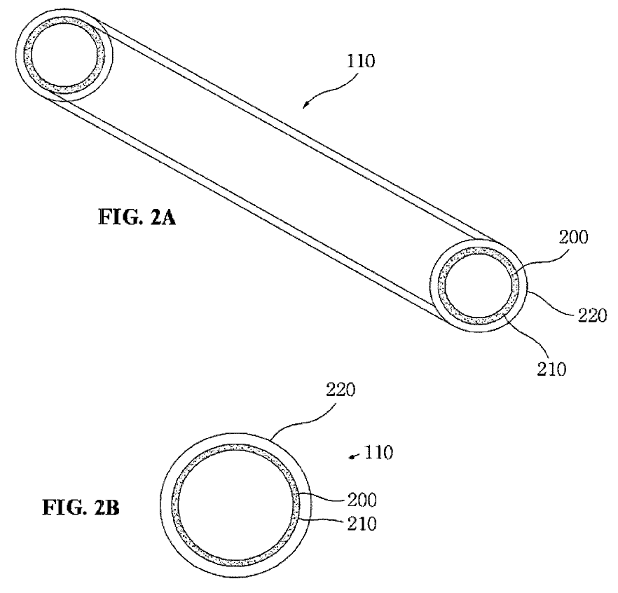

With reference to FIGS. 2A and 2B, an interior surface 210 of the discharge vessel 110 is coated with a coating material 200 possessing a large secondary electron emission coefficient.

If the coating material 200 coated on the interior surface 210 of the discharge vessel 110 possesses large secondary electron emission coefficient, the coating material 200 can enhance the illumination of the discharge lamp. Also, if the coating material 200 has secondary electron emission, it will not interfere with the transmission of visible light generated from the discharge gas. In addition, the coating material will have strong corrosion resistance against discharge gases, thereby functioning as a protective layer.

In various embodiments, the coating material 200 is MgO and/or carbon nanotubes. However, any coating material possessing a large secondary electron emission coefficient can be used in place of, or in addition to, the coating materials described above.

As one example of a coating material, MgO has a high secondary electron emission coefficient, in the range from about 0.3 to about 0.5, is resistant to ion sputtering, and is transparent. MgO can be used alone as a coating material, or it can be used together with MgF₂, AlN (aluminum nitride), CaO, CsO, CNT (carbon nanotube), LaB₆, or a mixture of any two or more such materials.

Among various methods suggested to prevent corrosion of the discharge vessel of discharge lamps, surface treatments of discharge vessels have been suggested. For instance, treating or coating surfaces of the discharge vessel with a coating material such as yttrium, zirconium, hafnium, lanthanium, scandium, has been developed and suggested to protect the discharge vessel from corrosion. However, one drawback to this method is that the coating layer formed by the coating material interferes with the illumination of the discharge lamps, thereby the illumination of a lamp significantly decreases.

In another aspect, a method for enhancing the illumination of the lamp 100 includes providing a coating material possessing large secondary electron emission coefficient to an interior surface 210 of a discharge vessel 110 of the lamp 100. If the exterior surface 220 of the discharge vessel 110 is coated with a coating material 200, the transmission is lowered, and accordingly the illumination of the discharge lamp 100 is lowered.

The method of applying the coating material 200 to the discharge vessel 110, is not particularly restricted, and any known method can be used. For example, various methods such as dip coating, spin coating as a sol-gel coating method, sputtering, E-beam evaporation, thermal evaporation, L-MBE (Laser Molecular Beam Epitaxy), PLD (Pulsed Laser Deposition), PVD (Physical Vapor Deposition), MOCVD (Metal-Organic Chemical Vapor Deposition), HVPE (Hydride Vapor Phase Epitaxy), and/or CVD (Chemical Vapor Deposition) can be used depending on the coating material 200 used. For example, where MgO is the coating material 200, the sol-gel coating methods may be used, or dip coating methods may be used.

After coating the discharge vessel 110 with the coating material 200, heat treatment of the coated discharge vessel is performed, according to some embodiments. The heat treatment time and heat treatment temperature may vary depending on the coating material 200 used. In some embodiments, the heat treatment time is from about 15 minutes to 5 hours. In some embodiments, the heat treatment time is from about 20 minutes to 3 hours. In some embodiments, the heat treatment time is from about 30 minutes to 2 hours. In some embodiments, the heat treatment temperature is from about 200° C. to 1000° C. In some embodiments, the heat treatment temperature is from about 250° C. to 800° C. In some embodiments, the heat treatment temperature is from about 300° C. to 700° C.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### EQUIVALENTS

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As used herein, “about” will be understood by persons of ordinary skill in the art and will vary to some extent depending upon the context in which it is used. Where “about” is applied to a range defined by two or more numbers, the term applies to both numbers in the range as if it were repeated before every number of the range, even though it may only be used before the first number. If there are uses of the term which are not clear to persons of ordinary skill in the art, given the context in which it is used, “about” will mean up to plus or minus 10% of the particular term.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed invention. Additionally the phrase “consisting essentially of” will be understood to include those elements specifically recited and those additional elements that do not materially affect the basic and novel characteristics of the claimed invention. The phrase “consisting of” excludes any element not specifically specified.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
enhancing an illumination of a lamp comprising:
coating an interior surface of a discharge vessel of the lamp with a coating material; and
heating the discharge vessel.

2. The method of claim 1, wherein the coating material is comprises MgO, carbon nanotubes, or a mixture thereof.

3. The method of claim 2, wherein the coating material is MgO.

4. The method of claim 1, wherein the coating material possesses a large secondary electron emission coefficient.

5. The method of claim 4, wherein the large secondary electron emission coefficient ranges from about 0.3 to about 0.5.

6. The method of claim 1, wherein the coating material increases the illumination of the lamp compared to a lamp without a coating material.

7. The method of claim 1, wherein the discharge vessel is made of a light-transmissive ceramic.

8. The method of claim 7, wherein the light-transmissive ceramic is alumina, silica, yttria, Y₃FeO₁₂, Y₃Al₅O₁₂, or mixtures of any two or more such materials.

9. The method of claim 8, wherein the light-transmissive ceramic is alumina.

10. The method of claim 1, wherein the lamp is an electric discharge lamp.

11. The method of claim 10, wherein the electric discharge lamp is a sodium vapor discharge lamp.

12. The method of claim 1, wherein the coating step comprises sol-gel coating.

13. The method of claim 1, wherein the coating step comprises dip coating.

14. The method of claim 1, wherein the heating is from about 300° C. to 700° C.

15. A lamp comprising a discharge vessel having a coating material.

16. The lamp of claim 15, wherein the coating material is MgO, carbon nanotubes, or a mixture thereof.

17. The lamp of claim 16, wherein the coating material is MgO.

18. The method of claim 15, wherein the coating material has a large secondary electron emission coefficient.

19. The method of claim 18, wherein the large secondary electron emission coefficient ranges from about 0.3 to about 0.5.

20. The method of claim 15, wherein an interior surface of the discharge vessel is coated with the coating material.

21. The lamp of claim 15, wherein the discharge vessel is made of light-transmissive ceramic

22. The lamp of claim 21, wherein the light-transmissive ceramic is alumina, silica, yttria, Y₃FeO₁₂, Y₃Al₅O₁₂, or mixtures of any two or more such materials.

23. The lamp of claim 22, wherein the light-transmissive ceramic is alumina.

24. The lamp of claim 21, wherein the lamp is an electric discharge lamp.

25. The lamp of claim 24, wherein the electric discharge lamp is a sodium vapor discharge lamp.

26. The lamp of claim 15, wherein the coating material increases the illumination of the lamp compared to a lamp without a coating material.

27. The lamp of claim 15, wherein the coating material protects the discharge vessel from corrosion.
